(19) United States
(12) Patent Application Publication
(10) Pub. No.: US 2002/0128911 A1
(43) Pub. Date: Sep. 12, 2002

(54) Electronic coupon method, electronic coupon system, marketing server, purchaser terminal, order-receiving terminal, and program

(75) Inventor: Toshio Furuta, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/091,555

(22) Filed: Mar. 7, 2002

(30) Foreign Application Priority Data
Mar. 12, 2001 (JP) 2001-068158

(51) Int. Cl. G06F 17/60

(52) U.S. Cl. 705/14

(57) ABSTRACT

A purchaser terminal of a plurality of purchaser terminals requests an electronic coupon for a product from a marketing server, whereupon the marketing server sends the requested electronic coupon to the purchaser terminal. The electronic coupon has buried in it discount information indicating a discount price or discount rate, this discount information being encrypted by means of an electronic watermark or the like. Upon the sending of the electronic coupon, the user of the purchaser terminal inputs a decryption instruction to the purchaser terminal, and in doing so the purchaser terminal decrypts the discount information buried in the electronic coupon and displays the decrypted discount information on a display unit. If the decrypted discount rate or discount price is satisfactory, the user of the purchaser terminal attaches the electronic coupon to order information and sends the same to the marketing server.

### BACKGROUND OF THE INVENTION

1. Field of the Invention

The present invention relates to electronic commerce via a network such as the Internet, and more particularly to electronic coupon technology introduced to promote commerce.

2. Related Art

In recent years, with the widespread use of information technology systems such as the Internet, there has been active use made of electronic commerce conducted via a network. Of these systems in which such electronic commerce is conducted, there are some in which refinements have been introduced to impart a feeling of inexpensiveness to users, thereby promoting business. Such a members' discount service system of the past is described below.

A marketing server in mutual connection with a member via a network, in response to a request from a member terminal, sends a product information list with regard to a product being marketed to the member terminal. When this is done, in order to give an impression of inexpensiveness to the member, the information includes the list price and discount information (rate of discount or amount of discount). The member terminal then displays a list of product information that is sent thereto from the marketing server on a display unit. When this is done, the display unit displays the list price in correspondence with discount information for each product. If there is a product among the product information that the member wishes to purchase, the member selects the product on the screen and places an order to the marketing server.

Although it is not used in the field of electronic commerce, in store sales done by supermarkets and the like in the US and Europe, discount coupons are used to promote sales of products by imparting an impression of inexpensiveness to consumers. Such discount coupons are generally distributed together with newspapers. The consumer takes the thus distributed coupon to a store and presents the coupon when purchasing a product, thereby enabling purchase of the product at a discount. Although in the Japanese unexamined laid-open patent applications H10-289271 and H10-312415, there is language-describing distribution of a discount coupon via a network, this coupon is for in-store sales, rather than for use in electronic commerce. That is, the electronic coupon of the above-noted patent disclosures is printed or stored in an IC card by a user, who then takes the electronic coupon to a store.

In the above-noted members' discount service system of the past, by displaying discount information for each product individually, the user is given the impression of inexpensiveness. This method, however, is not much different than the method generally used for indicating discount information for in-store sales, thereby making it difficult to promote sales of a product by giving the impression of inexpensiveness to a user.

Accordingly, it is an object of the present invention to adopt a new method for displaying discount information used in neither electronic commerce nor in-store sales, thereby giving the impression of inexpensiveness and promoting product sales.

### SUMMARY OF THE INVENTION

In order to achieve the above-noted object, the present invention has the following basic technical constitution.

Specifically, an electronic coupon method according to the present invention is one employed in a network system having a purchaser terminal, a marketing server, and a network via which the purchaser terminal and the marketing server are mutually connected, whereby

the marketing server manages product information for products that are being marketed and electronic coupons including encrypted discount information regarding the products, establishing a relationship of correspondence therebetween and, when there is a request to obtain an electronic coupon for a certain product from a purchaser terminal, sends the requested electronic coupon to the purchaser terminal which originated the request, and

the purchaser terminal displays the electronic coupon sent from the marketing server on a display unit and, in accordance with user's decryption instruction, the discount information encrypted in the electronic coupon by following interpreting instructions, and displays the same on a display unit.

According to the above-noted configuration, by merely obtaining an electronic coupon for a certain product from a marketing server and displaying the same on a display unit, it is not possible to know the discount information, but by performing an operation to extract the discount information hidden therewithin by means of an electronic watermark or the like, it becomes possible to know the discount information, so it is possible to provide more purchasing stimulus to a user by giving the impression of inexpensiveness, than was possible in the past.

In an electronic coupon method according to the present invention, in order for it to be possible for only a member to read the discount information encrypted in the electronic coupon, the purchaser terminal, in accordance with an instruction from a user wishing to become a member, sends to the marketing server membership application information that includes user information, and

the marketing server, upon receiving the sent membership application information from the purchaser terminal, records member information identifying the user that has applied for membership into a user information storage section, and sends a decryption key for the purpose of decrypting the discount information including in the electronic coupon to the purchaser terminal that sent the membership application information thereto.

Additionally, in an electronic coupon method according to the present invention, in order to prevent misuse,

order information includes the electronic coupon to be used, and

when the order information is sent from the purchaser terminal, the marketing server checks the validity of the electronic coupon included in the order information and, if the electronic coupon is not proper, refuses the order information and records the fact that an improper electronic coupon was used as historical information for the member who sent the order information.

### BRIEF DESCRIPTIONS OF THE DRAWINGS

FIG. 1 is a block diagram showing an example of the configuration of an embodiment of the present invention.

FIG. 2 is a block diagram showing an example of the configuration of an order-receiving terminal 100-i.

FIG. 3 is a block diagram showing an example of the configuration of a marketing server 200.

FIG. 4 is a block diagram showing an example of the configuration of a purchaser terminal 300-i.

FIG. 5 is a flowchart showing an example of processing at the time of a membership application.

FIG. 6 is a drawing showing an example of a membership application screen.

FIG. 7 is a flowchart showing an example of the processing at the time of storing product information and electronic coupon.

FIG. 8 is a flowchart showing an example of the processing when an electronic coupon is used to purchase a product.

FIG. 9 is a flowchart showing an example of the processing when an electronic coupon is used to purchase a product.

FIG. 10 is a drawing showing an example of a product information list screen.

FIG. 11 is a drawing showing an example of an electronic coupon.

### DETAILED DESCRIPTION OF THE PREFERRED EMBODIMENTS

Embodiments of the present invention are described in detail below, with reference made to relevant accompanying drawings.

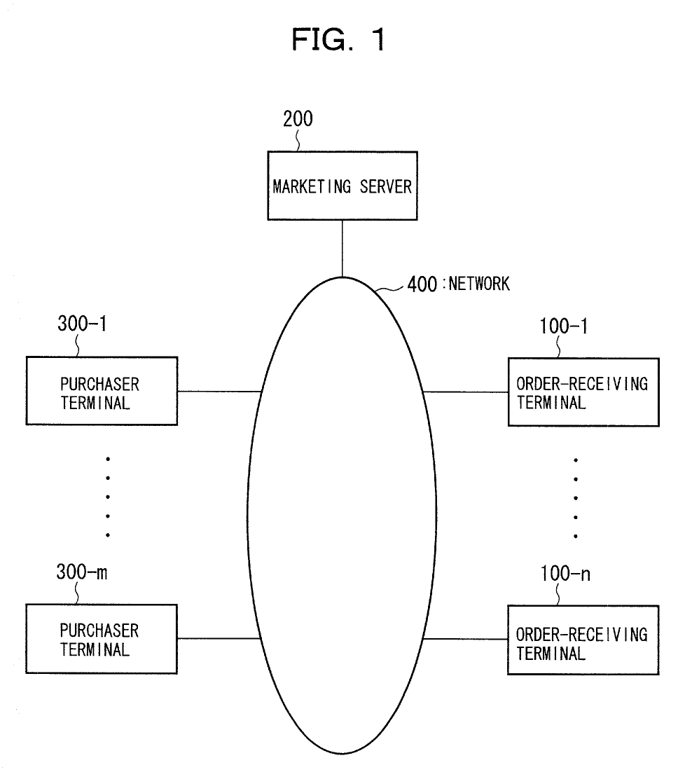

FIG. 1 is a block diagram showing an example of the configuration of a electronic coupon according to an embodiment of the present invention, this system being formed by a plurality of order-receiving terminals 100-1 to 100-n, a marketing server 200, a plurality of purchaser terminals 300-1 to 300-m, and a network 400, such as the Internet, via which the above elements are mutually connected.

An order-receiving terminal 100-i (where 1≦i≦n) is a terminal apparatus owned by a B to C (business-to-consumer) electronic commerce company or a B to B (business-to-business) electronic commerce company, which generates product information and electronic coupons for products being marketed, and has a function for sending the same via the network 400 to the marketing server 200. The above-noted electronic coupon has buried in it encrypted discount information (discount price or discount rate).

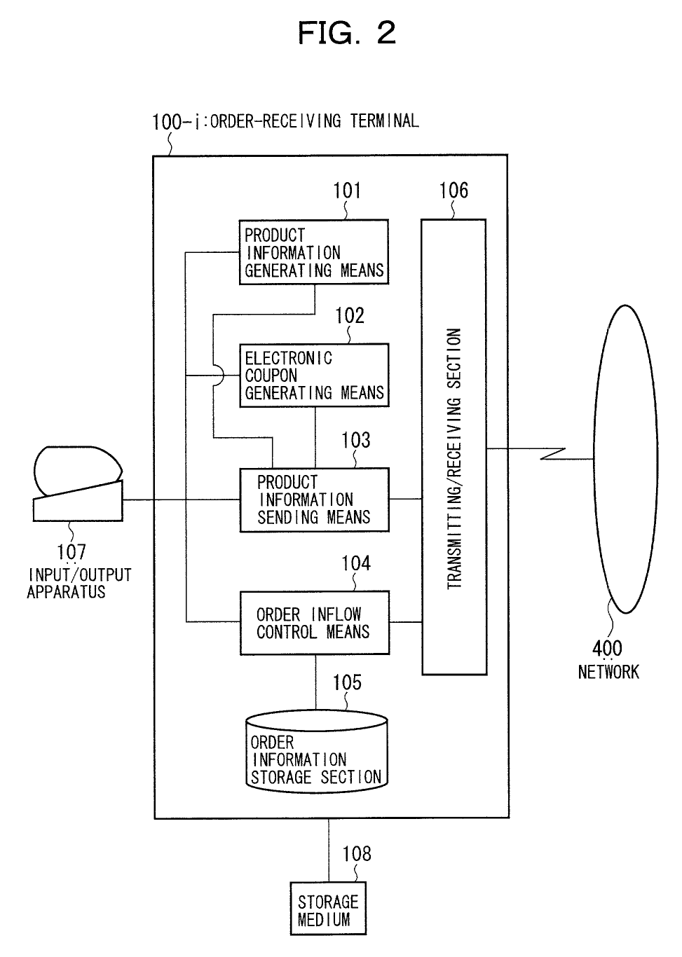

A order-receiving terminal 100-i having functions noted above is configured, as shown in FIG. 2, by a product information generating means 101, an electronic coupon generating means 102, a product information sending means 103, an order inflow control means 104, an order information storage section 105, a transmitting/receiving section 106, an input/output apparatus 107 formed by an input section such as a keyboard or the like and a display unit such as an LCD or the like, and a storage medium 108.

The product information generating means 101 has a function that, in accordance with an instruction from a user issued via the input/output apparatus 107, generates product information with regard to a product that is being marketed. The product information, in addition to product information such as a product name, product number, model number, price, specifications, seller, and the like, includes information as to whether or not there is an electronic coupon.

The electronic coupon generating means 102, has a function that, in accordance with a user instruction issued input/output apparatus 107, generates an electronic coupon, which includes encrypted discount information. The electronic coupon, in addition to encrypted discount information, includes a non-encrypted message, such as “This electronic coupon is for product XXXX.” While various methods are used to encrypt the discount information, in this embodiment the method of using an electronic watermark is employed.

The product information sending means 103 has a function that, in accordance with a user instruction issued via the input/output apparatus 107, in the case of a product for which an electronic coupon cannot be used, sends only the product information generated by the product information generating means 101 to the marketing server 200, and in the case of a product for which an electronic coupon can be used, sends the product information generated by the product information generating means 101 and the electronic coupon generated by the electronic coupon generating means 102 to the marketing server 200.

The order inflow control means 104 has functions which display delivery instructions sent from the marketing server 200 on the display unit of the input/output apparatus 107, and which store such information in the order information storage section 105.

The transmitting/receiving section 106 has the function of performing exchange of data with the marketing server 200 via the network 400.

The storage medium 108 is a storage medium such as a disk or a semiconductor memory or the like, and has stored in it a program for causing a order-receiving terminal 100-i implemented by a personal computer or the like to function as a part of the electronic coupon system. This program is read in by the order-receiving terminal 100-i and controls the operation thereof, so that the product information generating means 101, the electronic coupon generating means 102, the product information sending means 103, and the order inflow control means 104 are implemented in the order-receiving terminal 100-i.

The marketing server 200 is a server providing member discount service using electronic coupons, and has such functions as a function that manages product information and electronic coupons sent from each of the order-receiving terminal 100-i to 100-n, a function that in response to a request from an order-receiving terminal sends a product information list screen to the requesting terminal which originating said request, a function that in response to a request to obtain an electronic coupon from an purchaser terminal 300-j (where 1≦j≦m) sends the requested electronic coupon to the purchaser terminal 300-j which originating said request, a function that, when order information including an electronic coupon is sent from a purchaser terminal 300-j, checks the validity of the electronic coupon and then calculates the discount price, based on the discount information included in the electronic coupon, and performs receipt of payment using this calculated discount price.

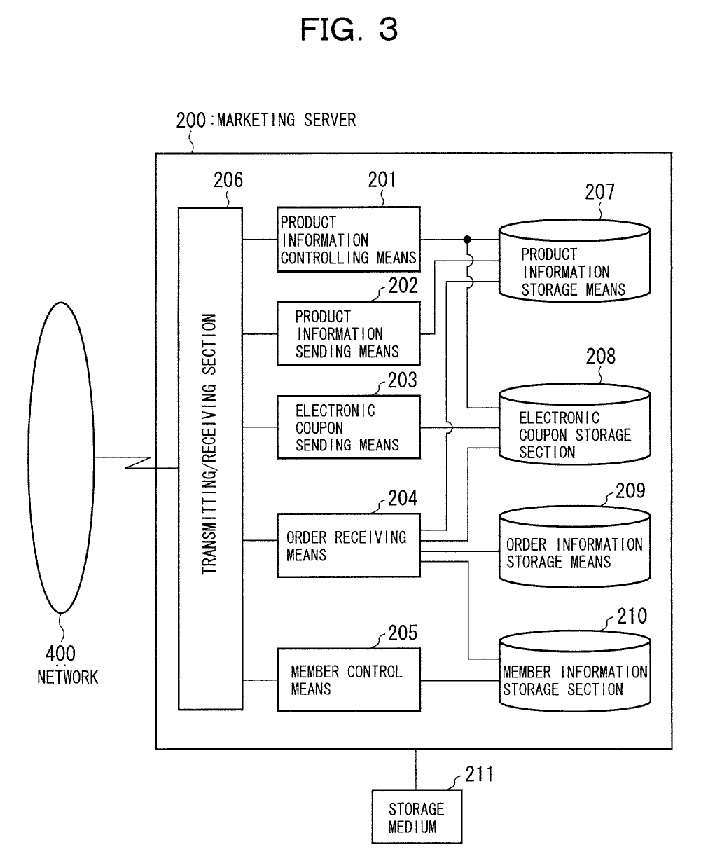

A marketing server having functions such as those noted above has, as shown in block diagram form in FIG. 3, a product information controlling means 201, a product information sending means 202, a electronic coupon sending means 203, an order receiving means 204, a member control means 205, a transmitting/receiving section 206, a product information storage section 207, an electronic coupon storing means 208, an order information storage section 209, a member information storage section 210, and a storage medium 211.

The product information storage section 207 and the electronic coupon storage section 208 are divided into regions for each the sellers of the order-receiving terminals 100-1 to 100-i.

The product information controlling means 201, in the case in which only product information is sent from an order-receiving terminal 100-i, stores the same in a region assigned to the order-receiving terminal 100-i within the product information storage section 207, and in the case in which both product information and an electronic coupon are sent, stores the product information and the electronic coupon in a region assigned to the order-receiving terminal 100-i in the product information storage section 207 and electronic coupon storage section 208. The establishment of correspondence between product information and an electronic coupon is done by adding a product number that is part of the product information to the electronic coupon.

The product information sending means 202 has a function which, in the case in which there is a request to obtain product information from purchaser terminal 300-j, sends to the purchaser terminal 300-j making the request a product information list screen which includes a list of products stored in the product information storage section 207.

The electronic coupon sending means 203 has a function which, in the case that there is a request from a purchaser terminal 300-j to obtain an electronic coupon for a given product which is soled by said order-receiving terminal 100-i, sends to the requesting purchaser terminal 300-jan electronic coupon corresponding to that product among the electronic coupons stored in the electronic coupon storage means 208.

The order receiving means 204 has the following function (a) to (d).

(a) A function which, when an order having an accompanying electronic coupon (including information indicating the number of a desired product, information indicating the seller of the product, and information indicating that the user is a member), checks the electronic coupon for validity and checks whether or not the user is a proper member.

(b) A function which, in the case in which both the electronic coupon and the user were verified as being valid, sends delivery instructions indicated by the order information to the order-receiving terminal of the seller, determines the discount price based on the discount information in the electronic coupon, and performs receipt of payment, based on this discount price.

(c) A function which rejects order information in the case in which at least one of the electronic coupon and the purchaser are invalid.

(d) A function which, in the case in which the electronic coupon is not valid, that is, in the case in which the member used an invalid electronic coupon, records in the member information storage section 201 the fact that an improper electronic coupon was used as historical information for the above-noted member.

The member control means 205 has functions such as a function which records member information identifying a user that has applied for membership into the member information storage section 210 when membership application information is sent from a purchaser terminal 100-i, and a function which returns joining authorization information, including a decrypting key for reading the discount information encrypted in the electronic coupon by an electronic watermark, a membership number, and a password and the like.

The transmitting/receiving section 206 has a function, which performs data exchange between the order-receiving terminals 100-1 to 100-n and the purchaser terminals 300-1 to 300-m, via the network 400.

The storage medium 211 is a storage medium such as a disk, semiconductor memory or the like, and has stored in it a program for causing the marketing server 200 implemented as a computer to function as part of the electronic coupon system. This program is read into the marketing server 200 and controls the operation thereof, thereby enabling the implementation of the product information controlling means 201, the product information sending means 202, the electronic coupon sending means 203, the order receiving means 204, and the member control means 205 on the marketing server 200.

The purchaser terminal 300-j has such functions as a function that sends membership application information to the marketing server 200, a function that controls membership authorization information sent from the marketing server 200, a function that sends a request to obtain product information to the marketing server 200, a function that displays a product information list screen sent from the marketing server 200, a function that sends a request to obtain an electronic coupon to the marketing server 200, a function that displays an electronic coupon sent from the marketing server 200 in which discount information is buried by means of an electronic watermark, a function that decrypts and displays discount information encrypted and buried in an electronic coupon in accordance with a user instruction, and a function that, when there is a purchase instruction from a user, attaches an electronic coupon to order information and sends it to the marketing server 200.

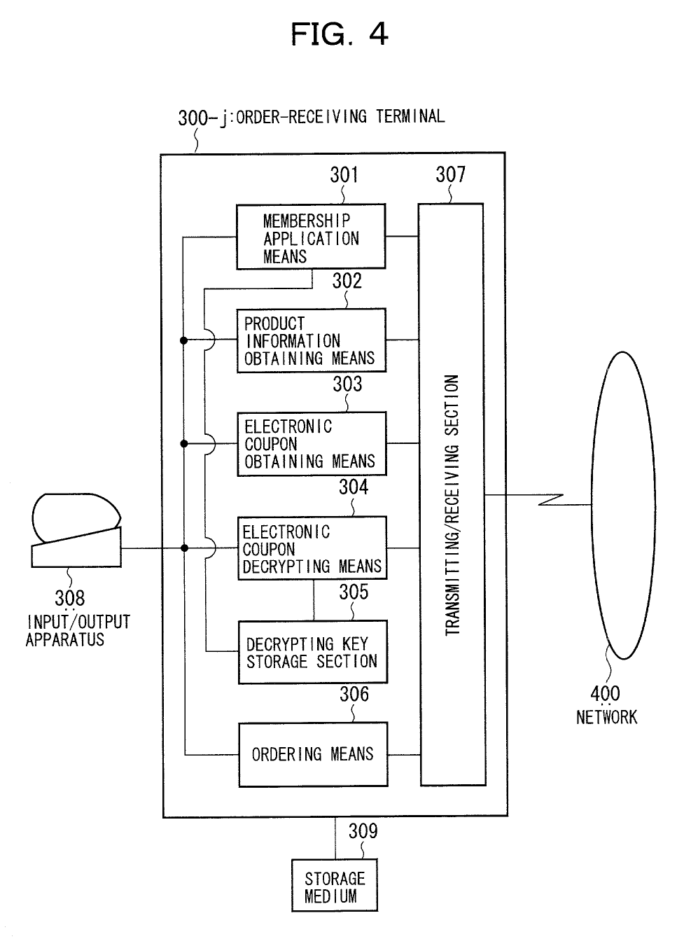

A purchaser terminal 300-j having the functions such as noted above, as shown in FIG. 4, is formed by a membership application means 301, a product information obtaining means 302, an electronic coupon obtaining means 303, an electronic coupon decrypting means 304, a decryption key storage section 305, an ordering means 306, a transmitting/receiving section 307, an input/output apparatus 308 formed by an input section such as a keyboard or the like and a display unit such as an LCD or the like, and a storage medium 309.

The membership application means 301 has functions such as a function that sends membership application information to the marketing server 200, a function that displays membership application information sent from the marketing server 200 on the display unit of the input/output apparatus input/output apparatus 308, and a function that decrypts and stores in the decryption key storage section 305 an decryption key included in the membership authorization information.

The product information obtaining means 302 has functions such as a function that, in accordance with a user instruction input via the input/output apparatus 308, requests product information to the marketing server 200, and a function that displays a product information list screen sent from the marketing server 200 on the display unit of the input/output apparatus 308.

The electronic coupon obtaining means 303 has functions such as a function that, in accordance with a user instruction input via the input/output apparatus 308, requests an electronic coupon to the marketing server 200, and a function that displays an electronic coupon sent from the marketing server 200 on the display unit of the input/output apparatus 308.

The electronic coupon decrypting means 304 has the function of, in response to a decryption instruction from a user via the input/output apparatus 308, using the decryption key stored in the decryption key storage section 305 to decrypt the discount information encrypted and buried in the electronic coupon displayed on the display unit of the input/output apparatus 308 using an electronic watermark, and display the decrypted results on the display unit.

The ordering means 306 has a function of, in accordance with a user instruction, sending order information containing an attached electronic coupon to the marketing server 200. The order information includes information indicating the product number of a desired product, information indicating the seller of the product, and information that the user is a member.

The transmitting/receiving section 307 has a function of performing exchange of data with the marketing server 200 via the network 400.

The storage medium 309 is a storage medium such as a disk or a semiconductor memory or the like, and has stored in it a program for causing the purchaser terminal 300-j, implemented as a computer, to function as a part of the electronic coupon system. This program is read into the purchaser terminal 300-j and controls the operation thereof, thereby implementing the membership application means 301, the product information obtaining means 302, the electronic coupon obtaining means 303, the electronic coupon decrypting means 304, and the ordering means 306 on the purchaser terminal 300-j.

The operation of this embodiment of the present invention is described below.

First, consider the operation input/output apparatus the case in which a user of the purchaser terminal 300-j wishes to become a member for a member discount service provided by the marketing server 200.

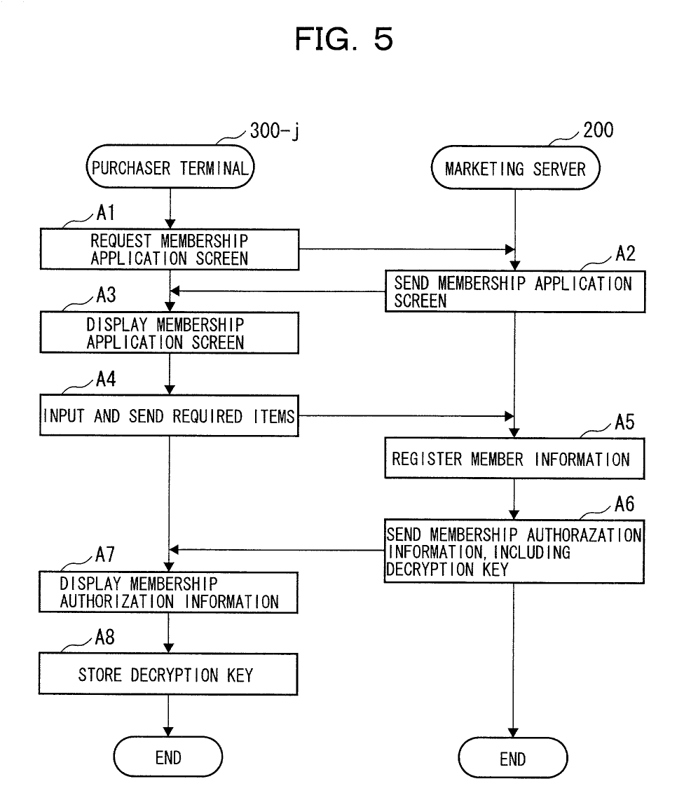

When application for membership is to be made, the user of the purchaser terminal 300-j, as shown in the flowchart of FIG. 5, request a membership application screen to the marketing server 200, using the membership application means 301 (step A1). By doing this, the member control means 205 within the marketing server 200 sends a membership application screen to the purchaser terminal 300-j that made the request (step A2).

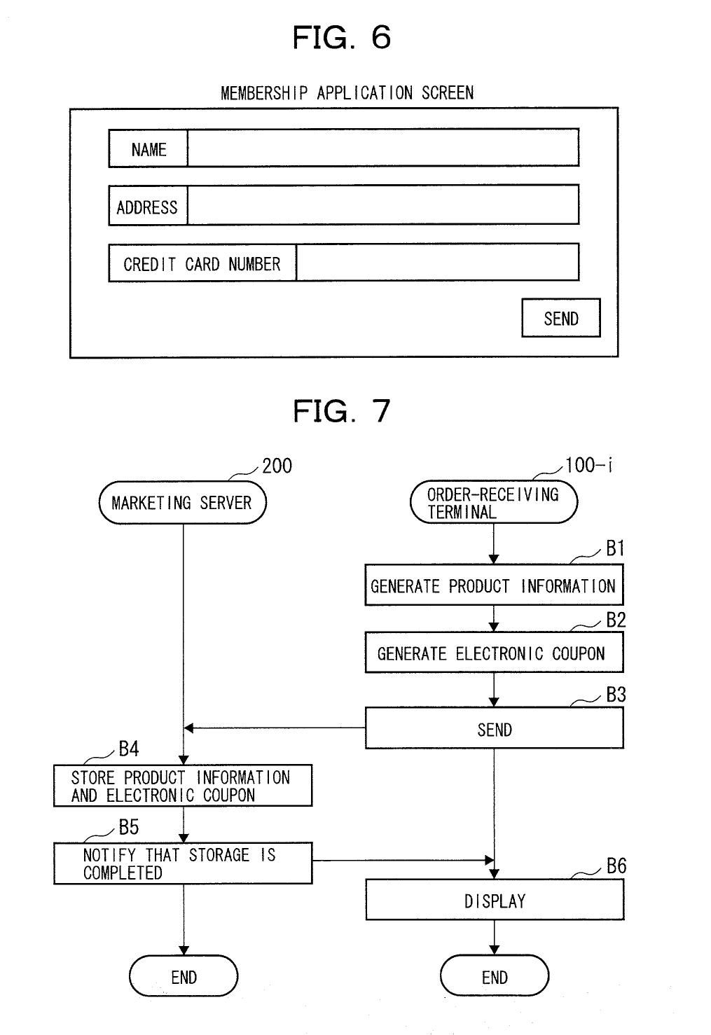

The membership application means 301 displays the membership application screen sent from the marketing server 200 on the display unit of the input/output apparatus 308 (step A3). The membership application screen, for example as shown in FIG. 6, has input fields for name, address, the credit card number that will be used for payment, and so on, and a send button. The user of the purchaser terminal 300-j inputs the required information into the various input fields of the membership application screen and then clicks the send button. By doing this, the membership application means 301 sends membership application information, including the information input at the various input fields, to the marketing server 200 (step A4).

When the membership application information is sent from the purchaser terminal 300-j , the member control means 205 in the marketing server 200 generates a membership number and a password that are assigned to the user of the purchaser terminal 300-j, and stores these, along with the member information including the name, address, and credit card number of the membership application information into the member information storage section 210 (step A5). After this is done, sends to the purchaser terminal 300-j membership authorization information, which includes the membership number and password generated at step A5, and the decryption key for the purposes of decrypting the discount information buried in encrypted form in the electronic coupon by means of an electronic watermark (step A6).

The membership application means 301 in the purchaser terminal 300-j displays the membership authorization information sent from the marketing server 200 on the display unit of the input/output apparatus 308, and stores the decryption key included in the membership authorization information into the decryption key storage section 305 (steps A7 and A8).

The above-mentioned explanations are the operation for application of the membership.

Next consider the operation when a purchaser terminal 100-i stores product information and an electronic coupon into the marketing server 200.

The administrator in charge of the order-receiving terminal 100-i uses the product information generating means 101 to generate product information for a product to be marketed (step B1 in FIG. 7). This product information includes a product name, model number, price, specifications, and information as to whether or not there is an electronic coupon. If the product is not one which is discounted with an electronic coupon, the administrator instructs the product information sending means 103 to send the product information, but in the case of a product that is purchased at a discount with an electronic coupon, the administrator, after using the electronic coupon generating means 102 to generate an electronic coupon having discount information buried therein which is encrypted by an electronic watermark, instructs the product information sending means 103 to send both the product information and the electronic coupon.

The product information sending means 103, in the case of being instructed to send the product information, sends only the product information generated at step B1 by the product information generating means 101 to the marketing server 200, but in the case in which it is instructed to send both the product information and the electronic coupon, the product information sending means 101 sends to the marketing server 200 the product information generated at step B1 and also the electronic coupon generated by the electronic coupon generating means 102 at step B2 as a pair(step B3).

In the case in which only the product information is sent from the order-receiving terminal 100-i, the product information controlling means 201 within the marketing server 200 stores the product information into an area of the product information storage section 207 assigned to the order-receiving terminal 100-i, and in the case in which both product information and an electronic coupon are sent from the order-receiving terminal 100-i as a pair, the product information controlling means 201 stores the product information and the electronic coupon, respectively, into the areas of the product information storage section 207 and electronic coupon storage section 208 assigned to the order-receiving terminal 100-i (step B4). When the electronic coupon is stored into the electronic coupon storage section 208, the product number, for example, that is appended to the product information that is sent paired therewith is also stored, so that it possible to know for what products an electronic coupon is usable.

After the above, the product information controlling means 201 notifies the order-receiving terminal 100-i of the completion of storage (step B5). By doing this, the product information sending means 103 within the order-receiving terminal 100-i displays the completion of storage on the display unit of the input/output apparatus 107 (step B6). The above is the operation occurring when storing product information and an electronic coupon.

Next, consider the operation in the case in which a user (member) of the purchaser terminal 300-j uses an electronic coupon to purchase a product.

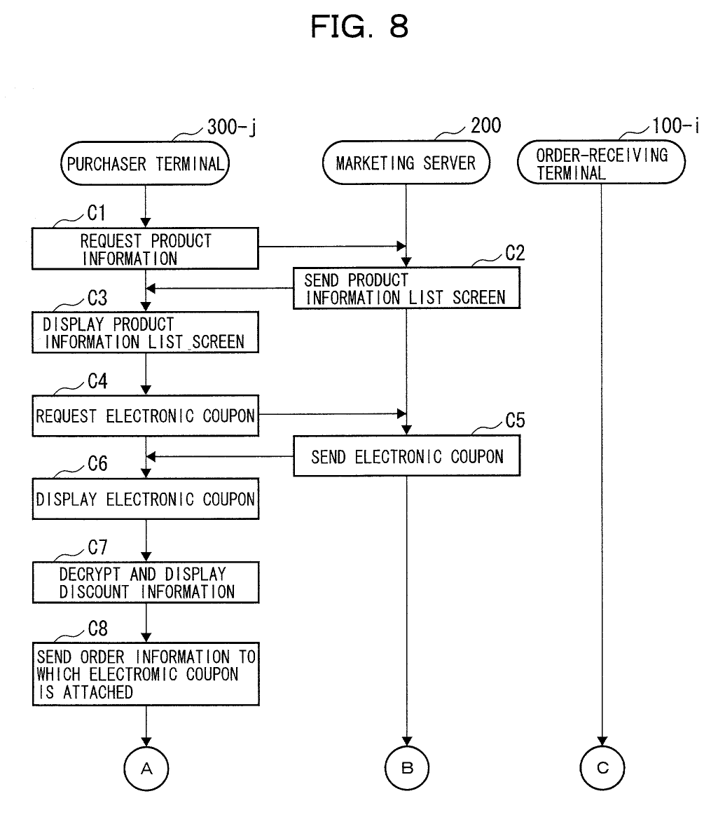

If the user of the purchaser terminal 300-j wishes to purchase a product being sold on the network 400 by the marketing server 200, the user first uses the product information obtaining means 302 to send a product information obtaining request to the marketing server 200 (step C1 in FIG. 8). By doing this, the product information sending means 202 within the marketing server 200 sends to the purchaser terminal 300-j that made the request a product information list screen, which includes a list of product information stored in the product information storage section 207 (step C2). It can alternately be arranged that the product information list screen be sent to the purchaser terminal 300-j only in the case in which the member number and password are included as part of the product information obtaining request sent from the purchaser terminal 300-j to the marketing server 200.

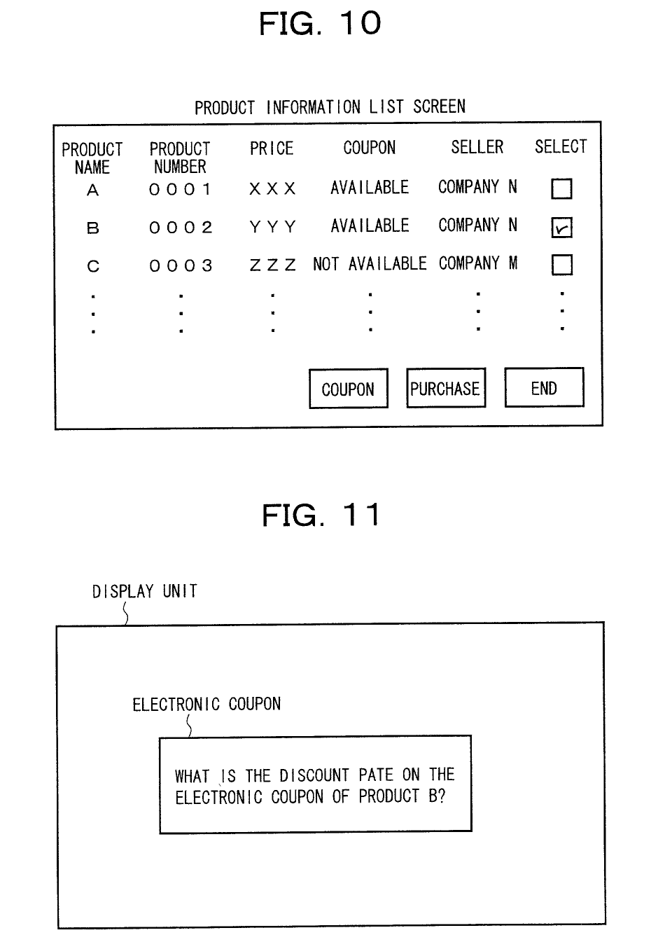

When the product information list screen is sent from the marketing server 200, the product information obtaining means 302 within the purchaser terminal 300-j displays this screen on the display unit of the input/output apparatus 308 (step C3). FIG. 10 shows an example of a product information list screen. The product information list screen shown in FIG. 10, in addition to product information such as product names, product numbers, prices, whether or not there is an electronic coupon, and the seller, includes fields for selecting products, a coupon button which is clicked to request an electronic coupon, a purchase button which is clicked to purchase a product, and an end button which is clicked to end processing.

The user of the purchaser terminal 300-j views the product information list screen and, if there is a product therein that the user wants to purchase due to a discount information of the electronic coupon as attached thereto, after checking the selection field for that product, the user clicks the coupon button. By doing this, the electronic coupon obtaining means 303 sends an electronic coupon request, including the information that identifies the electronic coupon, to the marketing server 200 (step C4). If, for example, as shown in FIG. 10, the user checks his selection field corresponding to the product name “B” and then clicks the coupon button, the electronic coupon obtaining means 303 sends to the marketing server 200 an electronic coupon obtaining request, which includes, for example, the product number 0002 and the seller Company N as information for identifying the electronic coupon.

Upon the sending of the electronic coupon obtaining request from the purchaser terminal 300-j, the electronic coupon sending means 203 within the marketing server 200 extracts the requested electronic coupon from the electronic coupon storage section 208 and sends the same to the purchaser terminal 300-j that had made the request (step C5). If, for example, the electronic coupon obtaining request including the product number 0002 and the seller name Company N is sent as information to identify the electronic coupon, the electronic coupon sending means 203 extracts from an area assigned to Company N in the electronic coupon storage section 208 an electronic coupon having the product number 0002 attached thereto, and sends this to the purchaser terminal 300-j that made the request.

When the electronic coupon is sent from the marketing server 200, the electronic coupon obtaining means 303 of the purchaser terminal 300-j displays the electronic coupon on the display unit of the input/output apparatus 308 (step C6).

Because this electronic coupon, as described above, has discount information encrypted by means of an electronic watermark and buried therewithin, merely displaying just results in a message such as shown in FIG. 11 being displayed, the discount information itself not being displayed.

When the electronic coupon is displayed, the user of the purchaser terminal 300-j uses the input/output apparatus 308 to issue a decryption instruction to the electronic coupon decrypting means 304. By doing this, the electronic coupon decrypting means 304 uses the decryption key stored in the decryption key storage section 305 to decrypt the discount information buried in the electronic coupon, and displays the decryption result on the display unit of the input/output apparatus 308 (step C7).

In this manner, in this embodiment of the present invention by sending to a user an electronic coupon having discount information encrypted by using an electronic watermark, it is possible to make the user first aware of the electronic coupon and, compared with conventional technology, in which the discount information is displayed beforehand, this provides better product sales promotion by giving the impression of inexpensiveness. Additionally, user is made to be expectant about just how inexpensive the product is as the user goes through the process, thereby making this more pleasurable than in the past.

In the case in which a user of the purchaser terminal 300-j is satisfied with the discount information displayed at step C7 and wishes to purchase the product using the electronic coupon in which the discount information is contained, return is made to the product information list display of FIG. 10, from which the purchase button is clicked. Even at that point the selection field that was checked at step C4 to obtain the electronic coupon is still usable. When the purchase button is clicked, the ordering means 306 generates information identifying the product corresponding to the checked selection field (for example, the product number and seller) and order information including the user's membership number and password, attached thereto the new electronic coupon that was sent from the marketing server 200, and sends this information to the marketing server 200 (step C8).

If the user does not wish to purchase a product even after viewing the discount information displayed at step C7, the user returns to the product information list screen and either clicks the end button or selects a different product and clicks the coupon button. If the user clicks the end button, processing is ended, and if the user clicks the coupon button, the above-described steps C4 to C7 are performed again in the same manner.

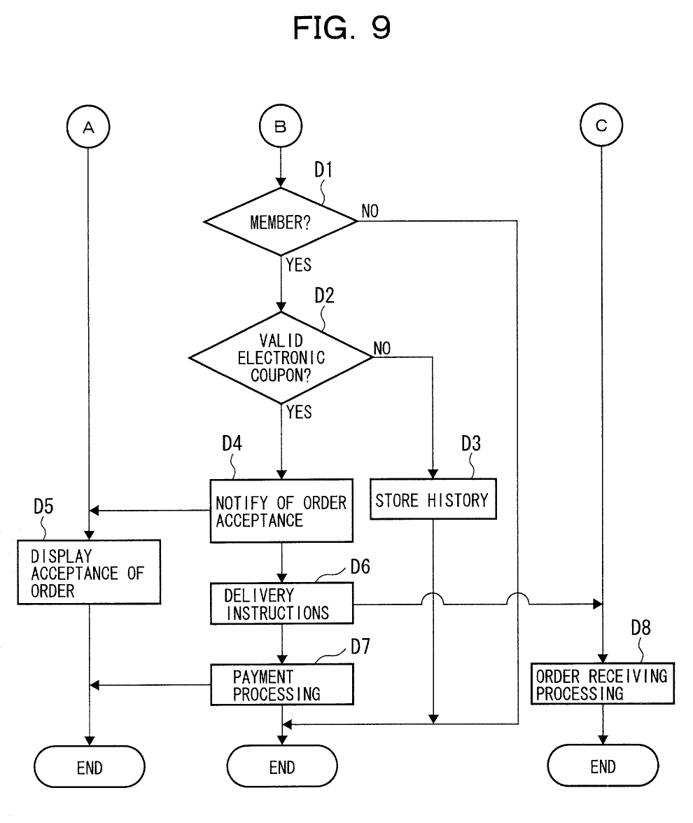

When the order information with an attached electronic coupon is sent from the purchaser terminal 300-j, the order-receiving means 204 in the marketing server 200, based on the membership number and the password included therein, and the content of the member information storage section 210, makes a check as to whether or not the user is an authorized member (step D1 in FIG. 9).

In the case in which the user was not a proper authorized member (NO result at step D1), the user is rejected, and processing stops. If the order information was from an authorized user, however, a check is made of the validity of the attached electronic coupon (step D2). This check can be performed as follows. First, a search is made of the area assigned to each seller included in the ordering information for each seller (for each order-receiving terminal) provided in the electronic coupon storage section 208, so as to search for an electronic coupon to which the product number included in the order information is attached. Then a comparison is made between the found electronic coupon and the electronic coupon attached to the order information. If there is a match, the coupon was valid, but if there was no match, the coupon will be judged to be invalid.

If the coupon was judged to be invalid at step D2 (NO judgment result), the order receiving means 204 stores in the member information storage section 210 the fact that an invalid electronic coupon was used as historical information for the user who sent the order information. In contrast, if the electronic coupon was judged to be valid (YES judgment result), the order information is stored into the order information storage section 209, and the notification is made to the purchaser terminal 300-j that the order has been accepted. When making notification of the acceptance of an orders the order receiving means 203 determines the price after the discount (discounted price) based on the discount information buried in the electronic coupon, and sends a order receipt notification, including the discount price, the product name, and the product number. By doing this, the purchaser terminal 300-j makes a display on the display unit of the input/output apparatus 308 to the effect that the order has been accepted (step D5).

After the above, the order receiving means 204 sends delivery instructions to the order-receiving terminal (for example the order-receiving terminal 100-i) of the seller indicated by the order information (step D6). These delivery instructions include the address and name of the user of the purchaser terminal 300-j, and the product number and name and the like of the purchased product.

Additionally, the order receiving means 204, in performing processing to receive payment for the product transaction, first uses the credit card number of the purchaser and payment processing is performed with the purchaser, based on the discount price determined at step D4. After this is done, payment processing is performed, based on the discount price, with the company owning the order-receiving terminal 100-i. When doing this, the brokering fee of the marketing server 200 can be invoiced to the company owning the order-receiving terminal 100-i.

When the delivery instructions are sent from the marketing server 200, the order receiving means 104 within the order-receiving terminal 100-i stores these in the order information storage section 105 or displays these on the display unit of the input/output apparatus 107 and performs order receiving processing that, for example, instructs a person in charge to ship the product (step D8).

A preferred embodiment of the present invention is described in detail above, and it will be understood that the present invention is not restricted to the above-described embodiment, but rather can take on various forms within the technical scope of the present invention.

As described in detail above, by encrypting discount information into an electronic coupon using an electronic watermark or the like, sending it to a user, and having the user perform a prescribed operation, the user is able to perceive that there is discount information from the beginning, so that the present invention provides more possibility to promote sales by giving an impression of inexpensiveness than a system of the past which revealed from start. Additionally, user is made to be expectant about just how inexpensive the product is as the user goes through the process, thereby making this more pleasurable than in the past.

Because the present invention provides discount information included in an electronic coupon only to members, it is possible only for members to decrypt the discount information encrypted as part of the electronic coupon.

Additionally, in the case in which an attached electronic coupon is not a valid one, the present invention records the fact that an invalid electronic coupon was used as historical information with regard to the user who sent it, thereby providing a check of members who behave improperly.

What is claimed is:

1. An electronic coupon method employed in a network system having a purchaser terminal, a marketing server, and a network via which said purchaser terminal and said marketing server are mutually connected, whereby
said marketing server manages product information for a marketed product and an electronic coupon including encrypted discount information regarding said product, establishing a relationship of correspondence therebetween and, when there is a request to obtain said electronic coupon for a certain product from a purchaser terminal, sends said requested electronic coupon to said purchaser terminal which originated said request, and wherein
said purchaser terminal displays said electronic coupon sent from said marketing server and, said user decrypts said discount information encrypted in said electronic coupon by following use's decryption instructions, and displays said information on a display unit.

2. An electronic coupon method employed in a network system having a purchaser terminal, a marketing server, and a network via which said purchaser terminal and said marketing server are mutually connected, whereby
said marketing server manages product information for a marketed product and electronic coupons including encrypted discount information regarding said product, establishing a relationship of correspondence therebetween,
said purchaser terminal displays on its own display unit product information managed by said marketing server and obtained via said network, and sends to said marketing server a request to obtain an electronic coupon corresponding to a product selected by an user viewing said display unit,
said marketing server sends said requested electronic coupon to said purchaser terminal which originated said request, in accordance with said request to obtain said electronic coupon sent from said purchaser terminal,
said purchaser terminal displays an electronic coupon sent from said marketing server on said display unit, decrypts discount information encrypted within said electronic coupon in accordance with user decryption instructions and display it on said display unit, and sends order information to said marketing server to the effect that said user will purchase said selected product, in accordance with user ordering instructions, with using said electronic coupon, and
said marketing server calculates a discount price based on discount information in said electronic coupon indicated for use by said order information sent from said purchaser terminal, and processes payment using said discount price.

3. An electronic coupon system according to claim 2, wherein said system is further provided with an order-receiving terminal connected to said marketing server via said network, whereby
said purchaser terminal sends product information regarding a marketed product and an electronic coupon including encrypted discount information to said marketing server, and
said marketing server manages said product information for said product sent from said purchaser terminal, and electronic coupon, establishing a relationship of correspondence therebetween.

4. An electronic coupon system according to claim 2 ,wherein
said purchaser terminal, in accordance with an operation by a user wishing to become a member, sends membership application information including user information identifying said user to said marketing server, and
said marketing server, when membership application information is sent from said purchaser terminal, records said member information identifying said applying user into a member information storage section, and sends a decryption key for decrypting discount information included in an electronic coupon to said purchaser terminal that sent said membership application.

5. An electronic coupon system according to claim 4, wherein
said order information includes an electronic coupon to be used, and
said marketing server, when order information is sent from said purchaser terminal, checks validity of said electronic coupon included in said order information and, in a case in which said electronic coupon is not valid, rejects said order information and stores use of an invalid electronic coupon as historical information of said user who sent said order information.

6. An electronic coupon system according to claim 5, wherein
said marketing server rejects order information from anyone but a user for whom member information has been registered in said member information storage section.

7. An electronic coupon system according to claim 6, wherein said user is either an individual user or a corporate user.

8. An electronic coupon system according to claim 1, wherein said discount information included in said electronic coupon is encrypted by means of an electronic watermark.

9. An electronic coupon system according to claim 1, wherein said discount information is a discount rate or a discount price.

10. An electronic coupon system according to claim 1, wherein said network is the Internet.

11. An electronic coupon system in a network system having a purchaser terminal, a marketing server, and a network via which said purchaser terminal and said marketing server are mutually connected, whereby
said marketing server manages product information for a marketed product and electronic coupons including encrypted discount information regarding said product, establishing a relationship of correspondence therebetween, and sends said electronic coupon to said purchaser terminal in accordance with said request to obtain the same when said request to obtain said electronic coupon is sent thereto from said purchaser terminal, and when an order information had sent from said purchaser terminal, calculates a discount price based on discount information in said electronic coupon indicated for use by said order, and processes payment using said discount price.
said purchaser terminal obtains product information managed by said marketing server via said network and displays on its own display unit, and sends to said marketing server a request to obtain an electronic coupon corresponding to a product selected by said user viewing said display unit, and when said electronic coupon is sent from said marketing server displays an electronic coupon sent from said marketing server on said display unit, when said user issues decryption instruction, decrypts and displays on said display unit discount information encrypted within said electronic coupon, and sends order information to said marketing server when said user issues said purchase order, to the effect that said user will purchase said selected product with using said electronic coupon.

12. An electronic coupon system according to claim 11, wherein
said marketing server comprises
a product information controlling means, which controls product information and an encrypted electronic coupon corresponding to said product information with a relationship of correspondence therebetween,
a product information sending means which, when a product information obtaining request is sent from said purchaser terminal sends said product information to said purchaser terminal in accordance with said obtaining request,
an electronic coupon sending means, which, when a electronic coupon obtaining request is send from said purchaser terminal, sends an electronic coupon to said purchaser terminal in accordance with said obtaining request,
and an order receiving means, which, when order information is sent from said purchaser terminal, calculates a discount price based on discount information in said electronic coupon indicated by a user by means of said order information, and performs settlement of payment, using said discount price,
and wherein said purchaser terminal comprises
a product information obtaining means, which sends a product information obtaining request to said marketing server via said network and displays product information sent from said marketing server in response to said product information obtaining request on its own display unit,
an electronic coupon obtaining means, which sends to said marketing server an electronic coupon obtaining request corresponding to a product selected by a user of products for which product information is displayed on said display unit, and displays an electronic coupon send from said marketing server in response to said electronic coupon obtaining request on said display unit,
an electronic coupon decrypting means, which when a user issues an instruction to decrypt, decrypts and displays on said display unit discount information encrypted in said electronic coupon, and
an ordering means, which, when there is an ordering instruction by a user, sends order information to the effect that said user will purchase said selected product using said electronic coupon.

13. An electronic coupon system according to claim 12, further comprising an order-receiving terminal, which comprises a product information sending means, which sends to said marketing server via said network product information for a marketed product and an electronic coupon including encrypted discount information for said product, and wherein
said product information controlling means controls said product information for said product and said associated electronic coupon sent from said order-receiving terminal with a relationship of correspondence therebetween.

14. An electronic coupon system according to claim 13, wherein said purchaser terminal comprises a membership application means, which, in accordance with an operation of a user desiring to become a member, sends membership application information including user information that identifies said user to the marketing server, and manages a decryption key sent from the marketing server in response to the membership application information, and wherein
said marketing server comprises a member control means, which, when membership application information is sent from the purchaser terminal, records member information identifying said applying user into a member information storage section, and sends to said purchaser terminal that sent said membership application information a decryption key for decrypting discount information included in an electronic coupon.

15. An electronic coupon system according to claim 14, wherein
said order information includes a electronic coupon to be used and wherein
said order-receiving terminal, when order information is sent from said purchaser terminal, checks validity of said electronic coupon included in said order information, and, in a case in which said electronic coupon is not valid, rejects said order information and records the use of an invalid electronic coupon as historical information of the sending user.

16. An electronic coupon system according to claim 15, wherein said order receiving means is configured so as to reject order information sent from a user unless member information of the user is registered in said member information storage section.

17. An electronic coupon system according to claim 16, wherein said user is either an individual user or a corporate user.

18. An electronic coupon system according to claim 11, wherein said discount information included in said electronic coupon is encrypted by means of an electronic watermark.

19. An electronic coupon system according to claim 11, wherein said discount information is a discount rate or a discount price.

20. An electronic coupon system according to claim 11, wherein said network is the Internet.

21. A marketing server comprising:
a product information controlling means, which controls product information and an encrypted electronic coupon including discount information corresponding to said product with a relationship of correspondence therebetween,
a product information sending means, which, when a product information obtaining request is sent from a purchaser terminal sends said product information to said purchaser terminal in accordance with said obtaining request;
an electronic coupon sending means, which, when a electronic coupon obtaining request is send from said purchaser terminal, sends an electronic coupon to said purchaser terminal in accordance with said obtaining request; and
an order receiving means, which, when order information is sent from said purchaser terminal, calculates a discount price based on discount information in said electronic coupon indicated by a user by means of said order information, and performs settlement of payment, using said discount price.

22. A purchaser terminal comprising:
a product information obtaining means, which sends a product information obtaining request to a marketing server via a network and displays product information sent from said marketing server in response to said product information obtaining request on its own display unit;
an electronic coupon obtaining means, which sends to said marketing server an electronic coupon obtaining request corresponding to a product selected by a user of products for which product information is displayed on said display unit, and displays an electronic coupon sent from said marketing server in response to said electronic coupon obtaining request on said display unit;
an electronic coupon decrypting means, which when a user issues an instruction to decrypt, decrypts and displays on said display unit discount information encrypted in said electronic coupon; and
an ordering means, which, when there is an ordering instruction by said user, sends order information to said marketing server to effect that said user will purchase said selected product using said electronic coupon.

23. An order-receiving terminal comprising:
a product information sending means, which sends to said marketing server via said network product information for a marketed product and an electronic coupon including encrypted discount information for said product.

24. A computer program for implementing an electronic coupon system in a network system having a computer for use as a purchaser terminal, a computer for use as a marketing server, and a network connecting said computers together, said computer program causing said marketing server computer to function as
a product information controlling means, which controls product information and an encrypted electronic coupon corresponding to said product information with a relationship of correspondence therebetween,
a product information sending means, which, when a product information obtaining request is sent from a computer for a purchaser terminal sends said product information to said computer for said purchaser terminal in accordance with said obtaining request;
an electronic coupon sending means, which, when a electronic coupon obtaining request is send from said computer for said purchaser terminal, sends an electronic coupon to said computer for said purchaser terminal in accordance with said obtaining request; and
an order receiving means, which, when order information is sent from a computer for said purchaser terminal, calculates a discount price based on discount information in said electronic coupon indicated by a user by means of said order information, and performs settlement of payment, using said discount price,
and causing the purchaser terminal computer to function as
a product information obtaining means, which sends a product information obtaining request to a computer for a marketing server via a network and displays product information sent from said computer in response to said product information obtaining request on its own display unit;
an electronic coupon obtaining means, which sends to a computer for said marketing server an electronic coupon obtaining request corresponding to a product selected by a user of products for which product information is displayed on said display unit, and displays an electronic coupon sent from said marketing server in response to said electronic coupon obtaining request on said display unit;
an electronic coupon decrypting means, which when a user issues an instruction to decrypt, decrypts and displays on said display unit discount information encrypted in said electronic coupon; and as
an ordering means, which, when there is an ordering instruction by said user, sends order information to effect that said user will purchase said selected product using said electronic coupon.
